(19) United States
(12) Patent Application Publication
(10) Pub. No.: US 2008/0043288 A1
(43) Pub. Date: Feb. 21, 2008

(54) DYE SUBLIMATION PRINTING METHOD

(76) Inventors: Hui-Ting Yang, Taoyuan County (TW); Sheng-Chih Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/532,113

(22) Filed: Sep. 15, 2006

(30) Foreign Application Priority Data
Aug. 17, 2006 (TW) 095130239

(51) Int. Cl. H04N 1/409

(52) U.S. Cl. 358/3.26

(57) ABSTRACT

To control printing in a printer image data of an edge region of a printing medium is received, then it is determined if the edge region contains a pixel whose gray level is higher than a predetermined gray level. The image data is updated by lowering gray levels if the edge region contains the pixel whose gray level is higher than the predetermined gray level. Then, a ribbon is heated to transfer dye on the ribbon to the printing medium according to a result of updating the gray levels of the image data.

### BACKGROUND OF THE INVENTION

1. Field of the Invention

The present invention relates to a printing method, and more particularly, to a method of printing in a dye sublimation printer that prints according to gray levels of pixels in an edge region of a print medium.

2. Description of the Prior Art

Please refer to FIG. 1. FIG. 1 is a diagram of a dye sublimation printer 1 according to the prior art. A ribbon 12 is driven by a ribbon providing reel 11 and a ribbon receiving reel 13. Thermal energy of a thermal printhead 10 causes dye on the ribbon 12 to be transferred to a printing medium, such as paper or a card.

Before the printer 1 begins printing, the thermal printhead 10 presses against the ribbon 12, and is in contact with an elastic component 14. At this time, the elastic component 14 provides a normal force to counteract a force applied to the ribbon 12 by the thermal printhead. When a card 15 is pushed into the printer 1, the elastic component 14 contracts slightly downward to provide space for the card 15. Because the card 15 has a thickness, before the thermal printhead 10 comes into contact with the card 15, the normal force provided by the elastic component 14 is released, and it is possible that the force applied to the ribbon 12 by the thermal printhead 10 will tear or damage the ribbon 12. Further, the thermal printhead 10 is in a heating state. If a temperature of the thermal printhead 10 is too high, in combination with the force applied to the ribbon 12 by the printhead 10, it is even easier for the ribbon 12 to tear. Likewise, when a trailing portion of the card 15 leaves the thermal printhead 10, it is also possible for the ribbon 12 to tear for the same two reasons just mentioned.

### SUMMARY OF THE INVENTION

According to the claimed invention, a method for controlling printing in a printer comprises receiving image data of an edge region of a printing medium, determining if the edge region contains a pixel whose gray level is higher than a predetermined gray level, updating the image data by lowering gray levels if the edge region contains the pixel whose gray level is higher than the predetermined gray level, and heating a ribbon to transfer dye on the ribbon to the printing medium according to a result of updating the gray levels of the image data.

According to the present invention, a second method of printing in a printer comprises utilizing gray levels that are lower than gray levels of image data corresponding to an edge region of image data to print to the edge region when the printer is printing to the edge region of the printing medium according to the image data, and utilizing gray levels of image data corresponding to a non-edge region of the image data to print to the non-edge region when printing to the non-edge region of the printing medium according to the image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a dye sublimation printer according to the prior art.

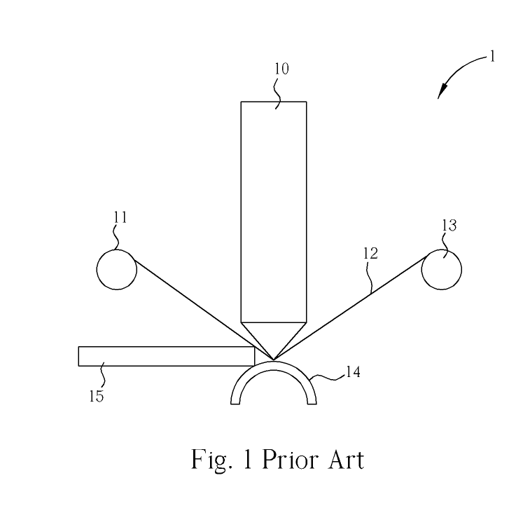

FIG. 2 is a flow chart of a method of printing in a dye sublimation printer according to the present invention.

### DETAILED DESCRIPTION

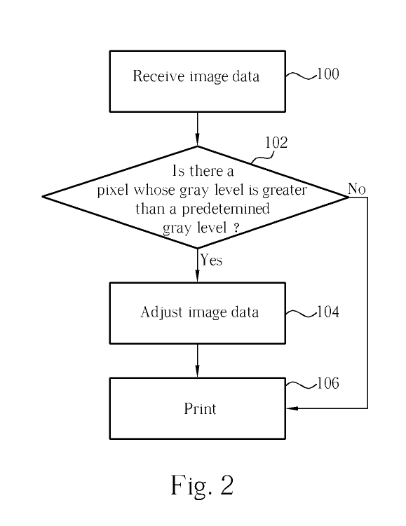

Please refer to FIG. 2. FIG. 2 shows a flow chart of a method of executing printing in a dye sublimation printer 1 according to the present invention. The method has the following steps:

Step 100: Receive image data;

Step 102: Determine respectively if the image data of a leading edge region and a trailing edge region of the image data about to be printed on the card 15 has a pixel whose gray level is greater than a predetermined gray level. If so, go to Step 104; else, go to Step 106.

Step 104: Adjust the image data in a region that meets determination conditions described in Step 102 by lowering the gray levels of all pixels in the region.

The leading edge region of the card 15 is taken as an example for the following description, however the same method is appropriate for use in the trailing edge region of the card 15. Assuming that the predetermined gray level is 200, if the image data to be printed in the leading edge region of the card 15 contains a pixel whose gray level is higher than 200 (the predetermined gray level), then the gray levels of all pixels in the leading edge region are lowered. Lowering of the gray levels of all pixels in the leading edge region of the card 15 can be performed in many different ways. For example, the gray levels of all of the pixels in the leading edge region of the card 15 could be lowered universally by one ratio (such as adjusting the gray levels down to half their original values), or the gray levels of all of the pixels in the leading edge region of the card 15 could be lowered by different ratios (such as lowering the gray levels of some pixels by a large ratio, but only lowering the gray levels of remaining pixels by a smaller ratio). Other than these methods, the gray levels of all of the pixels in the leading edge region of the card 15 could be adjusted linearly or nonlinearly.

Because it is very easy to tear the ribbon 12 when printing the leading and trailing edge regions of the card 15, the present invention only determines the gray levels of pixels in these two regions of the image data to lower the gray levels to prevent the thermal printhead 10 from overheating.

Step 106: Based on the image data, heat the thermal printhead 10 to print the card 15.

In Step 102, if neither the leading edge region nor the trailing edge region has any pixels with gray levels above the predetermined gray level, then in Step 106, the thermal printhead 10 is heated based on the original image data received.

In Step 102, if the pixels with the gray levels that are higher than the predetermined gray level are detected, then the thermal printhead 10 is heated in Step 106 according to the gray levels of the image data in the adjusted regions and the gray levels of the image data in the unadjusted regions when printing in the respective regions.

For example, if only the image data of the leading edge region is adjusted in Step 104, when leading edge region of the card 15 is printed in Step 106, the thermal printhead 10 is heated based on the image data after adjusting the leading edge region. When other regions are printed, the thermal printhead 10 is heated based on the original image data of the region.

In Step 102, it is very likely that more than one pixel will have a gray level that is higher than the predetermined gray level. In this case, assuming there exists a highest pixel whose gray level is higher than any other pixel whose gray level is higher than the predetermined gray level, in Step 104, lowering the gray levels of all pixels in the region can be performed according to the gray level of the highest pixel.

In addition, the present invention not only prevents the thermal printhead 10 from overheating by adjusting the gray levels of the image data in the leading and trailing edge regions, but the present invention can also adjust the thermal energy applied to the thermal printhead 10 to prevent the thermal printhead 10 from overheating.

The steps of determining the gray levels of the image data and adjusting the gray levels of the image data can be performed in a computer, then the updated image data can be sent to the printer. Or, the original image data can be sent to the printer, and the a processor of the printer can perform the determination and adjustment steps before printing.

It is easy for a ribbon of a dye sublimation printer to tear when printing a leading edge region and a trailing edge region of a card for two reasons: a mechanical reason, and overheating of a thermal printhead. Before printing, the present invention determines if image data in these two regions is likely to cause the thermal printhead to overheat. If so, the thermal printhead can be prevented from overheating by lowering gray levels of the image data, or by changing a thermal energy of the printhead. By eliminating the problem of overheating in the thermal printhead, a probability that the ribbon will tear when printing the leading edge region and the trailing edge region of the card is reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling printing in a printer comprising:
receiving image data of an edge region of a printing medium;
determining if the edge region contains a pixel whose gray level is higher than a predetermined gray level;
updating the image data by lowering gray levels if the edge region contains the pixel whose gray level is higher than the predetermined gray level; and
heating a ribbon to transfer dye on the ribbon to the printing medium according to a result of updating the gray levels of the image data.

2. The method of claim 1, wherein receiving the image data of the edge region of the printing medium to be printed on is receiving the image data of a leading edge region of the printing medium to be printed on.

3. The method of claim 1, wherein receiving the image data of the edge region of the printing medium to be printed on is receiving the image data of a trailing edge region of the printing medium to be printed on.

4. The method of claim 1, wherein receiving the image data of the edge region of the printing medium to be printed on is receiving the image data of an edge region of a card to be printed on.

5. The method of claim 1, wherein updating the image data by lowering gray levels is lowering the gray levels of all pixels of the image data by a ratio.

6. The method of claim 1, wherein updating the image data by lowering gray levels is lowering the gray levels of all pixels of the image data linearly or nonlinearly.

7. A method of printing in a printer comprising:
utilizing gray levels that are lower than gray levels of image data corresponding to an edge region of image data to print to the edge region when the printer is printing to the edge region of the printing medium according to the image data; and
utilizing gray levels of image data corresponding to a non-edge region of the image data to print to the non-edge region when printing to the non-edge region of the printing medium according to the image data.

8. The method of claim 7, wherein utilizing the gray levels that are lower than the gray levels of the image data corresponding to the edge region of the image data to print to the edge region when the printer is printing to the edge region of the printing medium according to the image data is utilizing the gray level that is lower than the gray level of the image data corresponding to a leading edge region of the image data to print to the leading edge region when the printer is printing to the leading edge region of the printing medium according to the image data.

9. The method of claim 7, wherein utilizing the gray levels that are lower than the gray levels of the image data corresponding to the edge region of the image data to print to the edge region when the printer is printing to the edge region of the printing medium according to the image data is utilizing the gray level that is lower than the gray level of the image data corresponding to a trailing edge region of the image data to print to the trailing edge region when the printer is printing to the trailing edge region of the printing medium according to the image data.
